(19) United States
(12) Patent Application Publication
(10) Pub. No.: US 2014/0107811 A1
(43) Pub. Date: Apr. 17, 2014

(54) Transfer Of Responsibility In A Multisystem Environment

(71) Applicants: Kjell Y. Svensson, Vasteras (SE); Lena Nilsson, Vasteras (SE)

(72) Inventors: Kjell Y. Svensson, Vasteras (SE); Lena Nilsson, Vasteras (SE)

(21) Appl. No.: 14/104,918

(22) Filed: Dec. 12, 2013

Related U.S. Application Data
(63) Continuation of application No. PCT/EP2011/060838, filed on Jun. 28, 2011.

(51) Int. Cl. G05B 15/02

(52) U.S. Cl. CPC G05B 15/02
USPC 700/19

(57) ABSTRACT

A control computer in a first system is involved in controlling an industrial process via a computer object, which object acts on a process interface device and is controllable from the first and from a second system by operators in these systems, and the control computer includes an object handling unit configured to receive a request from a requesting operator concerning responsibility of a group of objects at least including the object, set, in the first system, an operator identified by the request to be responsible for the group and when responsible operator is set, only allow control of the group from the responsible operator.

### FIELD OF THE INVENTION

The present invention relates to the field of computer based process control systems. The invention more particularly relates to a method and computer program product for handling control of a computer object in a first system as well as to a control computer of this system.

### BACKGROUND OF THE INVENTION

Object based computer systems are today used for controlling industrial processes.

WO01/02953 entitled “Method of integrating an application in a computerized system” discloses a method for integration of many and various types of applications in a computerized system. The method is based on a concept where real world objects are represented as “composite objects”. Different facets of a real world object, such as its physical location, the current stage in a process, a control function, an operator interaction, a simulation model some documentation about the object, etc., are each described as different aspects of the composite object. A composite object is a container for one or more such aspects. Thus, a composite object is not an object in the traditional meaning of object-oriented systems, but rather a container of references to such traditional objects which implement the different aspects. Each aspect or group of aspects may be implemented by an independent software application, which provides its functionality through a set of interfaces that are accessible through the composite object. Another software application can thus query a composite object for a function associated with one of its aspects, and as a result obtain through the composite object, a reference to the interface that implements the function.

The use of containers and aspects in a process control system is also described in WO03/032233 entitled “Data access method for a control system”.

Both these documents thus describe the use of containers and aspects that are provided based on COM objects.

It is also known to interconnect two object based process control systems. This is for instance described in WO 2007/097679. Here a process being run in one of the systems may be controlled in this system but also from the other system. Such an interconnection of two systems can with advantage be used when the staff is to be reduced for instance at night.

This interconnection of systems or multisystem environment thus opens up a flexibility in that a process run in one system can be controlled from more systems than this one system. However, this is not only advantageous, but can also lead to problems. Since a process being run in one system can be controlled from another system, it is possible that counteracting control commands may be issued from operators in different systems, which can have a negative effect on the control and may in fact even be hazardous. There is therefore a need for improvement when providing a multisystem environment.

There is therefore a need for providing an improvement in the control of processes in a multisystem environment.

### SUMMARY OF THE INVENTION

The present invention is therefore directed towards improving on the control of processes in a multisystem environment.

One object of the present invention is to provide an improved method for handling control of a computer object in a first system.

This object is according to a first variation of the present invention achieved through a method for handling control of a computer object in a first system for controlling an industrial process, the object acting on a process interface device and being controllable from the first and from a second system by operators in these systems, the method being performed by an object control handling unit and comprising the steps of:
receiving, in the first system, a request from a requesting operator concerning responsibility of a group of objects at least comprising said object,
setting, in the first system, an operator identified by said request to be responsible for the group, and
when responsible operator is set, only allowing control of the group from the responsible operator.

Another object of the present invention is to provide a control computer in a first system involved in controlling an industrial process, which control computer provides an improved control when the first system is part of a multisystem environment.

This object is according to a second variation of the present invention achieved through a control computer in a first system and involved in controlling an industrial process via a computer object, the object acting on a process interface device and being controllable from the first and from a second system by operators in these systems, the control computer comprising:

an object handling unit configured to
receive a request from a requesting operator concerning responsibility of a group of objects at least comprising said object,
set, in the first system, an operator identified by said request to be responsible for the group, and
when responsible operator is set, only allow control of the group from the responsible operator.

Another object of the present invention is to provide a computer program product for handling control of a computer object in a first system, which computer program product provides improved control when the first system is part of a multisystem environment.

This object is according to a third variation of the present invention achieved through a computer program product for handling control of a computer object in a first system for controlling an industrial process, the object acting on a process interface device and being controllable from the first and from a second system by operators in these systems,

the computer program product comprising a data carrier with computer program code implementing an object handling unit of a control computer in the first system, the computer program code being configured to, when the code is loaded in the control computer:
receive a request from a requesting operator concerning responsibility of a group of objects at least comprising said object,
set, in the first system, an operator identified by said request to be responsible for the group, and
when responsible operator is set, only allow control of the group from the responsible operator.

The present invention has many advantages. It enables the ensuring of an orderly change of responsible operator to be made in a secure way without jeopardizing the control. This may also be combined with the flexibility of allowing control from several different operators in certain cases.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows the general layout of a first system for controlling an industrial process,

FIG. 2 schematically shows the first and a second control system that are connected to each other using a first and a second control computer in the two systems,

FIG. 3 shows a block schematic of units in the first control computer in the first system communicating with units in the second control computer in the second system,

FIG. 4 schematically shows how process control devices being controlled are represented in the systems,

FIG. 5 schematically shows an example of one realization of an object handling unit and an object store,

FIG. 6 shows a flow chart outlining a method according to a first embodiment of the present invention being performed by an object handling unit in the first system,

FIG. 7 shows a number of additional method steps that may be performed by the object handling unit in the first system,

FIG. 8 schematically shows a multisystem environment where there are more interconnected systems, and

FIG. 9 schematically shows a computer program product in the form of a CD Rom disc comprising computer program code for carrying out the invention.

### DETAILED DESCRIPTION OF THE INVENTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

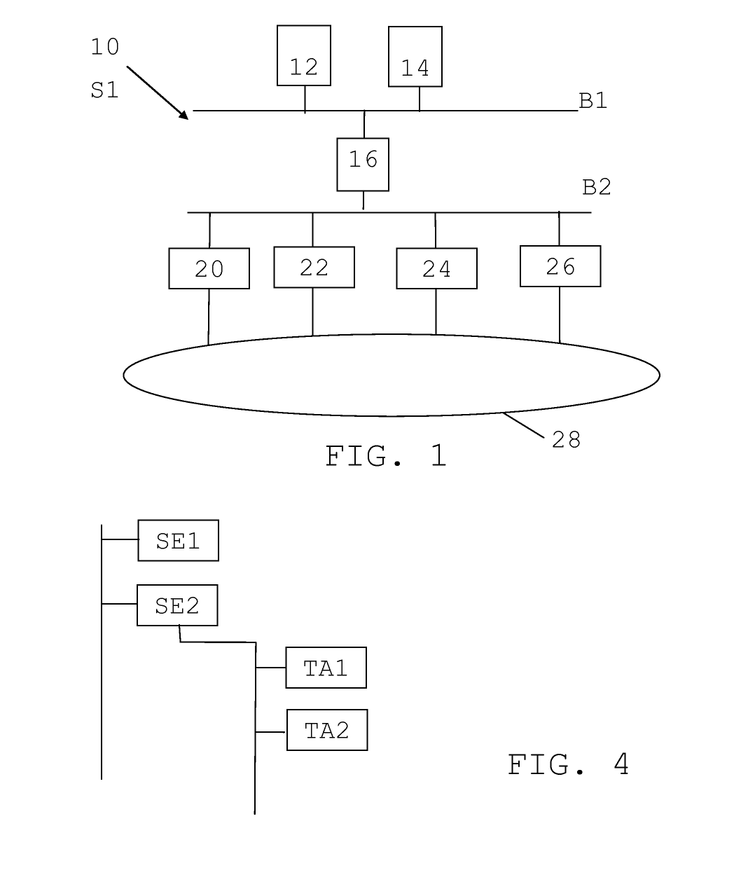

FIG. 1 schematically shows a first control system S1 10 controlling a process 28 or a part of a process. The first system 10 is thus a process control system. The process 28 may be an industrial process and may furthermore be any of a number of different types of processes such as a pulp and paper production process, a water purification and distribution process, oil and gas production and distribution process, petrochemical, chemical, pharmaceutical and food process, an electric power transmission process or an electric power distribution process. These are just some examples of processes where the system 10 can be applied. There exist countless other processes. The control system 10 is here an object based computerised system for controlling the process 28.

In FIG. 1 the first process control system 10 includes a number of computers 12 and 14 connected to a first bus B1. There is here a first computer 12 that is a first operator terminal and a second computer that is an engineering terminal 14. There is furthermore a second bus B2 and between the first and second busses there is connected a first control computer 16 providing control of the process 28. To the second bus B2 there are furthermore connected process interface devices 20, 22, 24 and 26 for providing control of the process 28. These devices are sometimes referred to as field devices and are also real world objects involved in the control of the process. They are thus controlled by the first control computer 16. In the figure there are provided four such process interface devices 20, 22, 24 and 26 that interfaces the process 28. It should however be realized that there may be more or fewer of each of these devices. Such devices are thus all involved in controlling the process 28 and in doing this one or more may be involved in measuring physical properties related to the process. The measured properties may here be properties of the process itself such as a voltage of or current running in a power line or the pulp temperature of a pulp and paper process.

It should also be realised that there may be many more control computers as well as more engineering and operator terminals.

The first control computer 16 normally has some local software for controlling one or more process interface devices, which may be different entities that influence the industrial or technical process, like such things as a pump, a motor, a valve, a tank etc. for instance realized through one or more of the process interface devices 20, 22, 24 and 26. The process may also be monitored through the first operator terminal 12, which communicates with the first control computer.

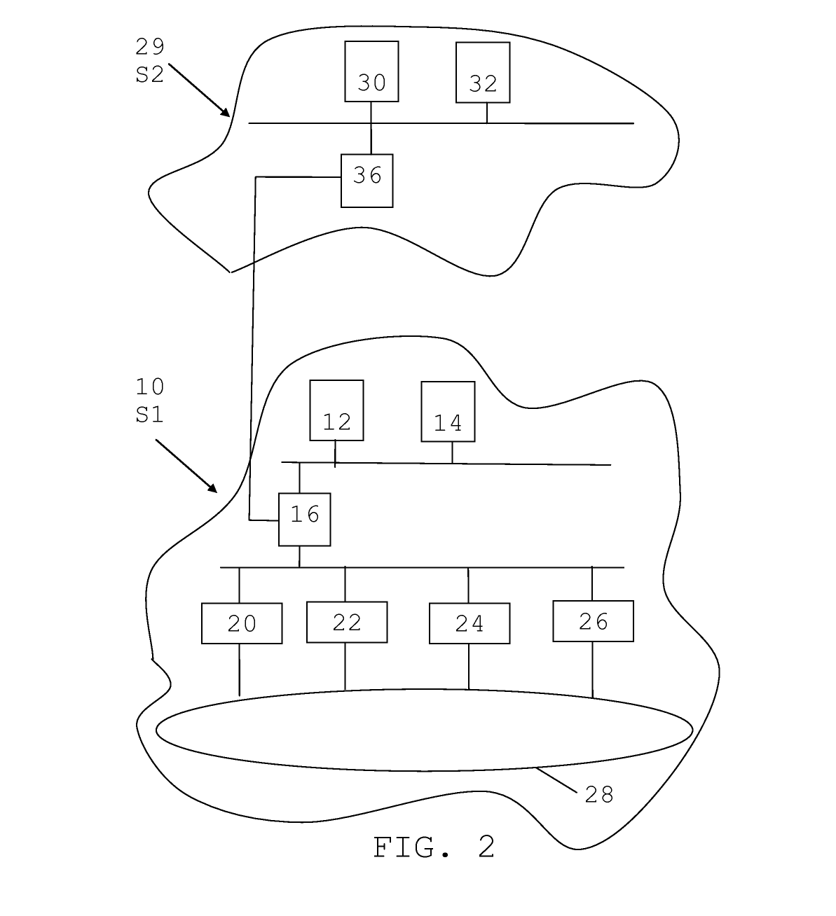

FIG. 2 schematically shows the first control system S1 10 being connected to a second control system 29 S2, which is also a computerized control system. The first system 10 is here the same system that was shown in FIG. 1 and is a system on a first hierarchical level, while the second system 29 is a system on a second higher hierarchical level. The second system 29 may here be provided for controlling an own process. It may thus be equipped with own process interface devices. However, that is not necessarily the case. The second system 29 may not have an own process that it controls but may only be provided for controlling the process 28 of the first system 10 as well as perhaps processes of other systems on the same hierarchical level as the first system.

In FIG. 2 the first system 10 is shown as comprising the same entities as in FIG. 1. The second system, S2 29 includes a second operator terminal 30, a third operator terminal 32 as well as a second control computer 36. It should here be realized that the second system is greatly simplified in order to provide a clearer understanding of the invention. Therefore possible process interface devices have here been omitted and engineering terminals also omitted.

In order for the two systems to communicate with each other the two control computers 16 and 36 are connected to each other. The first control computer 16 of the first system 10 is thus connected to the second control computer 36 of the second system 29. They may more particularly be connected to each other via an interfacing arrangement, for instance an arrangement including a gateway and a firewall. However, here also this interfacing arrangement is omitted.

FIG. 3 shows a block schematic of the two control computers when communicating with each other and with operator terminals of the two systems. In the figure there is shown how the first control computer 16 comprises a first object handling unit 40 communicating with a first object store 42 and with a remote access server (RAS) 38 as well as with the first operator terminal 12 at which a first operator OP1 is indicated.

The second control computer 36 in turn comprises a second object handling unit 46 communicating with a corresponding second object store 48, with a remote access client (RAC) 44 as well as with the second and third operator terminals 30 and 32. Here a second operator OP2 is indicated as being located at the second operator terminal 30 and a third operator OP3 at the third operator terminal 32.

The remote access server 38 and remote access client 44 are furthermore communicating with each other.

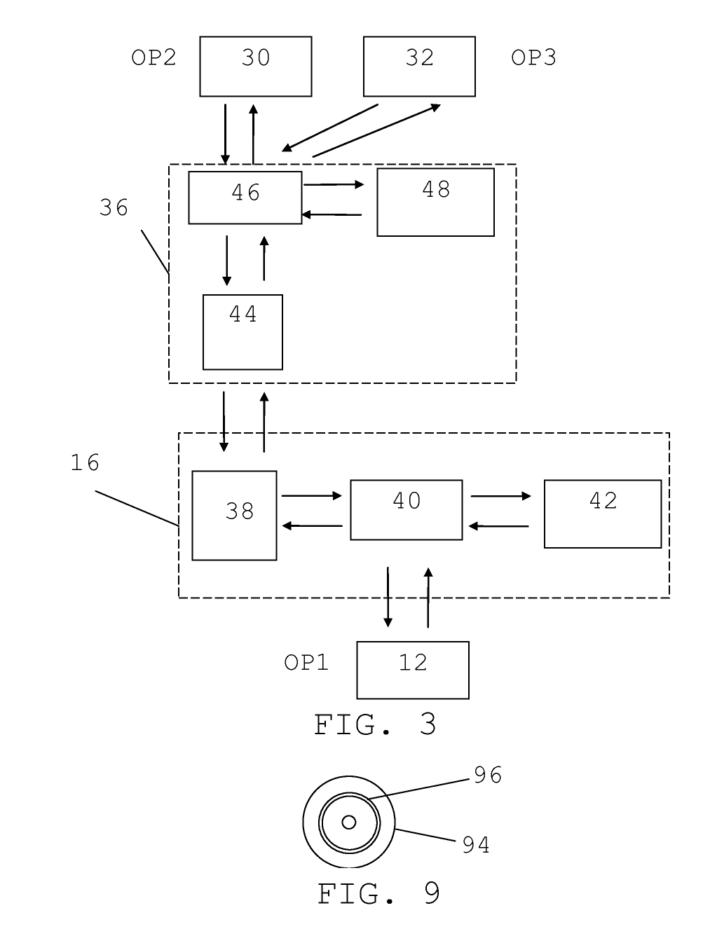

Computer objects representing physical objects, like process interface devices, being controlled are typically graphically presented in a hierarchical structure. An example of one such structure is schematically shown in FIG. 4, which shows a simplified hierarchical tree structure. Here there is shown a first section SE1 and a second section SE2 and in the second section SE2, there is a first object, here a first tank TA1 and a second object, here a second tank TA2, which objects may be controlled by operators in the first system. These graphical objects are typically representations of process interface devices in the first system, which process interface devices are controlled by computer objects.

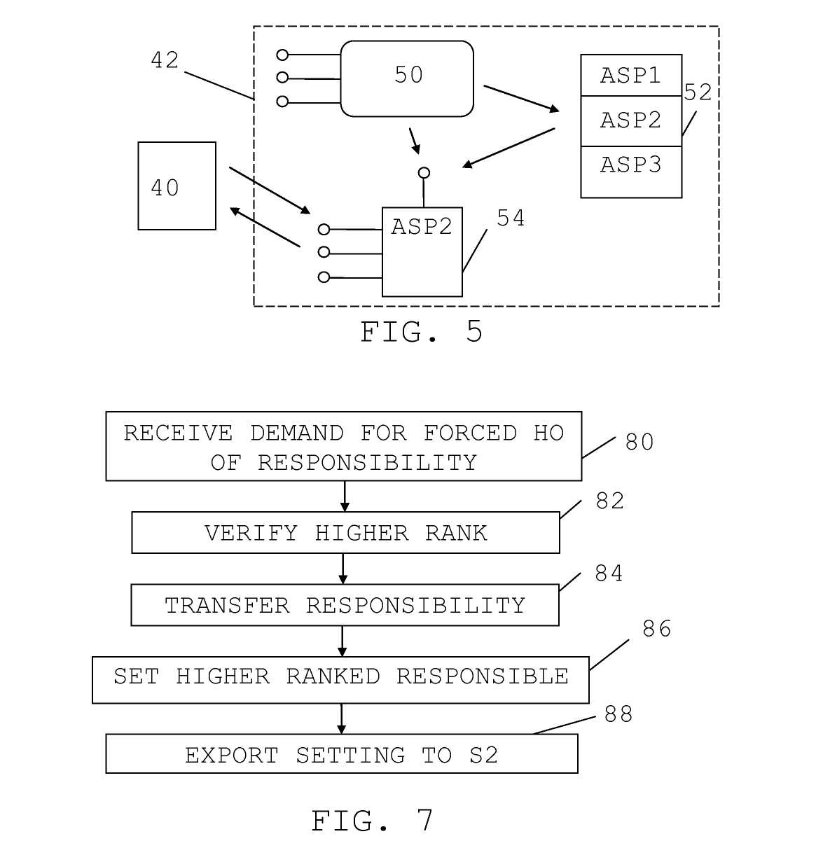

In order to control the process interface devices of a process, containers may be used, where there may be one container for each process interface device. FIG. 5 shows a block schematic of the first object handling unit 40 and object store 42, where the object store 42 comprises a container Cont 50, an aspect Asp2 54 and an aspect lookup table 52.

The container 50 is a so-called COM object having a number of interfaces, where three are shown in FIG. 5. COM is an existing published standard and as such is a part of the prior art. More information about COM may for instance be found in the Microsoft MSDN Online Library on the web site maintained by Microsoft. Additional information about COM may also be found in, amongst others, an article in Dr. Dobbs Journal December 1994 entitled The Component Object Model: Technical Overview. WO 01/02953, which is herein incorporated by reference.

Through the container 50, an object handling unit 40 can invoke a function that is related to an aspect that is held by the container 50. The object handling unit 40 does this by querying the container 50 for an interface to this function, without knowing the identity of the application that implements the function for which it is seeking an interface. If the container has an aspect that supports the interface then a reference to the interface is returned as some form of pointer to where that interface may be found.

The container 50 thus holds a number of aspects, of which one Asp2 54 is shown in FIG. 5. Each aspect, which thus may be provided as a COM object, is related to a process interface device provided in the first system 10 or a group of process interface devices. An aspect represents one facet of this real world object, and is responsible for all operations on that facet of the object and its data. Thus for a tank for example, one aspect could represent a physical location, another aspect could represent a blue print diagram of the tank, another a security descriptor for the tank, another aspect could represent a control for an operation of the tank and yet another aspect could represent documentation about the tank. Yet a further aspect may be a responsibility aspect of the tank setting out details of operators being responsible for the computer object. The aspect that represents the facet has an association to a function of an application that can, referring to the above example, display the blue-print diagram control the operation of the pump or apply security settings. All aspects are created through an aspect category. The aspect category contains information that is shared between all instances of the category. Each aspect category refers to one aspect type. This aspect type describes the implementation of an aspect. The container does itself not hold any data, but data is provided in aspects or in relation to aspects. An aspect belongs to an aspect type (through its category) which lists the set of COM objects that implements the functionality of the aspect. This implementation is provided by an object, referred to as an Aspect System Object (ASO), which is a COM compliant object. Stated differently, the aspect type contains the binding information between an aspect and the one or more applications that implement its functionality.

The container furthermore has access to an aspect lookup table 52, through which it may locate an aspect.

Thus the first object handling unit 40 when needing to access a facet of the real world object, i.e. process interface device, connects to the container 50 and requests an interface associated with said facet. The container then locates an aspect 54 associated with the facet via the aspect table 52, interrogates the aspect regarding its interfaces, receives information of an interface and returns the interface, through which the object handling unit may connect to the aspect for retrieving data, control the real world object, etc. What has been described so far is known within the art and not a part of the present invention. Details regarding this is described in further detail in WO 01/02953, which is herein incorporated by reference. Here it can be seen that through this structure, where computer objects made up of containers and aspects controls the industrial process, which is done through the computer objects acting on corresponding process interface devices, typically through employing an aspect.

What has been described above is thus the normal way containers and aspects function when they are provided in one and the same system. It is furthermore possible that containers relating to process interface devices in the first system may be provided in the second system and vice versa. This is described in more detail in WO 2007/097679, which is also incorporated by reference.

In order to be able to upload information about containers from the first system the object handling unit 46 of the second system may communicate with the RAC 44. The RAC 44 may also be provided as a container, which has a number of aspects handling communication with the first system. In the same way the RAS 38 may here also be a container having a number of aspects handling communication with the RAC 44. Through this structure it is possible that a proxy container is created for and mapped to an original container and that the aspects are copied or that proxy aspects are created. All this is described in more detail in WO 2007/097679.

This type of interconnection of systems or multisystem environment allows the control of process interface devices provided in the first system from the second system in a seamless fashion. It thus allows a computer object that acts on a process interface device to be controllable by operators in the connected systems. This is advantageous in many situations, for instance when control is to be transferred for instance temporarily. From the viewpoint of the operators of the second system, the control does furthermore not appear to be remote but local.

However, this flexibility has a downside and that is that it is possible that several operators in the two systems may interact with the first system simultaneously. This may also lead to an operator in the second system performing an operation on the same object in the first system as an operator in the first system. This could in relation to the above described tank means that one operator may control the tank to fill it, while another operator may control the tank to empty it. Such contradictory commands may be very harmful in some processes and therefore there may exist a need for providing a way to safely hand over responsibility of control between operators in the two process control systems.

The invention addresses this problem.

A first embodiment of the present invention will therefore now be described with reference being made to the previously described drawings as well as to FIG. 6, which shows a flow chart outlining a method according to this first embodiment being performed by the first object handling unit 40 of the first control computer 16 in the first system 10.

The invention will now also be described in relation to the tank TA1 and the section SE2 in which it is provided. The tank may here be provided through one or more of the process interfaces to the process 28, here through the first process interface device 20.

The method starts by the first object handling unit 40 receiving a request concerning responsibility for a group of computer objects from a requester or requesting operator, step 56. In this example the requesting operator is the second operator OP2. The first object handling unit 40 thus receives the request from a requesting operator. The request is in this embodiment a request made by the requesting operator to become a responsible operator. It is thus a request for responsibility. The group comprises at least one object, here the object defining the first tank TA1, but may also comprise more objects, for instance a whole section, like all the objects in the second section SE2. The request furthermore identifies an operator which the requesting operator desires to be responsible for the group. In this example it is the requesting operator him- or herself that is indicated. The request is here also a request by the requesting operator to have sole control of the object. A responsible operator does thus in normal circumstances have sole control of an object, in which case no other operator would be allowed to control the object. Such a request could be received from an operator of the first system, such as the first operator OP1, in which case the first object handling unit 40 in the first control computer 16 would receive it from the first operator terminal 12. However, it may also be received from an operator in the second system, for instance the second operator OP2.

In this example the request is received from the second operator OP2. Therefore the second object handling unit 46 would receive the request from the second operator and forward this request to the first object handling unit 40 via the RAC 44 and RAS 38.

After the first object handling unit 40 has received the request, it then investigates if any other operator is a current responsible operator, which may be done through investigating the responsibility aspect of the tank object or of an object representing the second section SE2. If there is no current responsible operator, step 58, then the first object handling unit 40 immediately continues to step 70. If there is no current responsible operator being set, this may mean that up until the reception of a request for responsibility any operator in the first and second system may have been allowed to control the objects of the group. It is also possible that a limited group of operators in the first and second systems were allowed to control the objects of the group.

If however, another operator was responsible, i.e. there is a currently responsible operator, step 58, then the request identifies a candidate responsible operator, which in this example thus was the second requesting operator OP2. Furthermore as there already exists a currently responsible operator, a counterpart operator to the requesting operator is queried. The counterpart operator has the opposite role of the requesting operator. Since the requesting operator in this example is a candidate operator, here also an operator desiring to be responsible, the counterpart operator will be an operator that is currently responsible. This means that the current responsible operator is queried, step 60. This query is here a query of if the currently responsible operator is willing to allow responsibility to be transferred to the requesting operator. In the present example the first operator OP1 may be currently responsible and then the query may be sent to the first operator terminal 12 of the first operator OP1, via which terminal 12 the first operator OP1 may also reply. In case the currently responsible operator was an operator in the second system 29, the query would be forwarded to the second object handling unit 46 via the RAS 38 and RAC 44, which second object handling unit 46 would then query the current responsible operator via a corresponding operator terminal, where a response could also be entered. The response would then also be forwarded from the second object handling unit 46 to the first object handling unit 40 via the RAC 44 and RAS 38.

It is here possible that the currently responsible operator is occupied with a task, which task may involve a series of control activities, for instance the filling of the tank, performing some activity in the tank and thereafter emptying the tank TA1. It is in this situation possible that a currently responsible operator cannot handover responsibility to another operator unless this task is finished. The operator may thus only be allowed to be relieved of the responsibility after the task is finished. This may in the example given here be implemented through the first object handling unit 40 waiting with sending the query until the task is finished or not allowing the accepting of transfer of responsibility from the currently responsible operator until the task is finished.

After having received a response, the first object handling unit 40 investigates the response, which is an investigation of if the currently responsible operator accepted the transfer or not.

If the counterpart operator, here the currently responsible operator, does not accept, step 62, then the request is denied, step 64, and a response setting out this fact sent to the operator requesting responsibility. In the present example a response would be sent to the second operator terminal 30 used by the second operator OP2. The first object handling unit would then also only allow control from the currently set responsible operator, step 74, i.e. the one denying the request.

If however the counterpart operator accepts, step 62, then the responsibility is transferred to the candidate responsible operator identified by the request according to the wishes of the requester, step 66. In this way the candidate operator is made into a currently responsible operator and in this example it is the second operator OP2 that is made into this new currently responsible operator. This could also involve the upload of one or more computer objects defining the group. The first object handling unit 40 may therefore upload the computer objects of the tanks TA1 and TA2 to the second object handling unit 46 for provision in the second object store 48. This uploading may be performed in the way described in WO 2007/097679. Because of this the first object handling unit 40 may be considered to be a provider unit and the second object handling unit may be considered to be a subscriber unit.

The transfer of responsibility would here also involve setting the requesting operator as responsible in the first object store 42, step 70, which in the present example involves setting the second operator OP2 as responsible. This may here involve the first object handling unit 40 changing the data in the responsibility aspect of the one or more objects in the object store 42 defining the group to reflect the fact that the second operator OP2 is now responsible. The setting may here also involve a setting of the location of the new responsible operator. In case the responsible operator is an operator in the first system, i.e. the system in which the process interface device is located, then the location may be specific, for instance through specifying the section in which the operator is present, as an example the second section SE2. However, in case the operator is present in another system, then the location may be more general for instance through only referring to the system. In case the new responsible operator is the second operator OP2 this location information may thus be limited to identifying the second system 29. Here it is also possible that operator locations in the first system are impossible to view in the second system and vice versa.

This also implies that it will be possible to take responsibility for a section from any operator terminal in the second system or not at all.

The new currently responsible operator has now been set in the first system 10. However, it may be necessary to also set the currently responsible operator also in the second system 29. Therefore the first object handling unit 40 may export the setting to the second system, step 72. This may be done through the first object handling unit 40 connecting to the second object handling unit 46 via the RAS 38 and RAC 44, which second object handling unit 46 may perform the same setting in a copied aspect of a proxy object corresponding to the computer object in the first system that has been set. This may also be done through only performing uploading of the computer object or computer objects of the section after this change has bee done.

As the setting has now been made in relation to both the first and second object handling units 40 and 46, both these units now only allow control from the currently set responsible operator, step 74. In the given example the transfer of responsibility involves a transfer of responsibility from one of the systems to the other.

The first object handling unit 40 then acts on commands from the currently responsible operator and only the currently responsible operator.

This means that now the currently responsible operator, and only the currently responsible operator, may control process interface devices controlled by the group of computer objects, for instance through invoking a process control aspect of the computer object representing the process interface device 20.

If at any time that the first object handling unit 40, which enforces this strict limitation of control to the currently responsible operator terminal, receives a request for responsibility from another operator than the currently responsible operator, step 76, then the currently responsible operator is again queried, step 60, the acceptance investigated, step 62, responsibilities changed, step 66, new responsible operator set, step 70, and setting optionally exported, step 72, while if no such request for responsibility is received from another operator, step 76, the first object handling unit 40 continues and investigates if the currently responsible operator requests to be released from the responsibility. If such a request is received, step 77, then the operator is released, step 78, with a consequential change of the setting in both the first and the second object stores 42 and 48. However, in case no request is received, step 77, then strict enforcing of control rules are continued, step 74.

If a currently responsible operator being occupied with a task requests to be released from being responsible, it is also here possible that this is not allowed until the task is finished.

In this way it can be seen that the first object handling unit enables the ensuring of an orderly change of responsible operator to be made in a secure way without jeopardizing the control. This is also combined with the flexibility of allowing control from several different operators in certain cases.

It should here be realized that the first embodiment described above can be varied in a number of ways. It is for instance possible that a responsible operator can investigate if another operator is willing to take over responsibility instead of passively waiting to get contacted. In this case it is of course not necessary to query the responsible operator but perhaps instead the candidate to take over. This thus means that in this example the requester is the currently responsible operator, while the counterpart is the candidate operator. The transfer of responsibility could also always involve a transfer between the first and the second system. It is also possible that an operator is never allowed to be released from being responsible unless there is another operator ready to become responsible.

Another possible variation of the invention is that two operators may request to become responsible for a group simultaneously, for instance two operators in different systems, where one may be an operator in the first system and the other may be an operator in the second system. In this case the operators in the first system are given priority for becoming responsible operators. This means that their requests are handled before the requests of the operators in the second system.

Furthermore if the connection between the first and second control computers is broken, and an operator in the second system is the currently responsible operator, it is possible that the responsibility will automatically be released by the first object handling unit. When the communication is up again, this operator in the second system may then need to retake responsibility.

It should here also be realized that a setting need not be exported to the second system, which would be the case if the second object handling unit communicated directly with computer objects in the first system.

It is also possible that the upload of a part of a section will not be allowed, for instance only one object. It is possible that only complete sections of objects are allowed to be uploaded or subject of responsibility transfer.

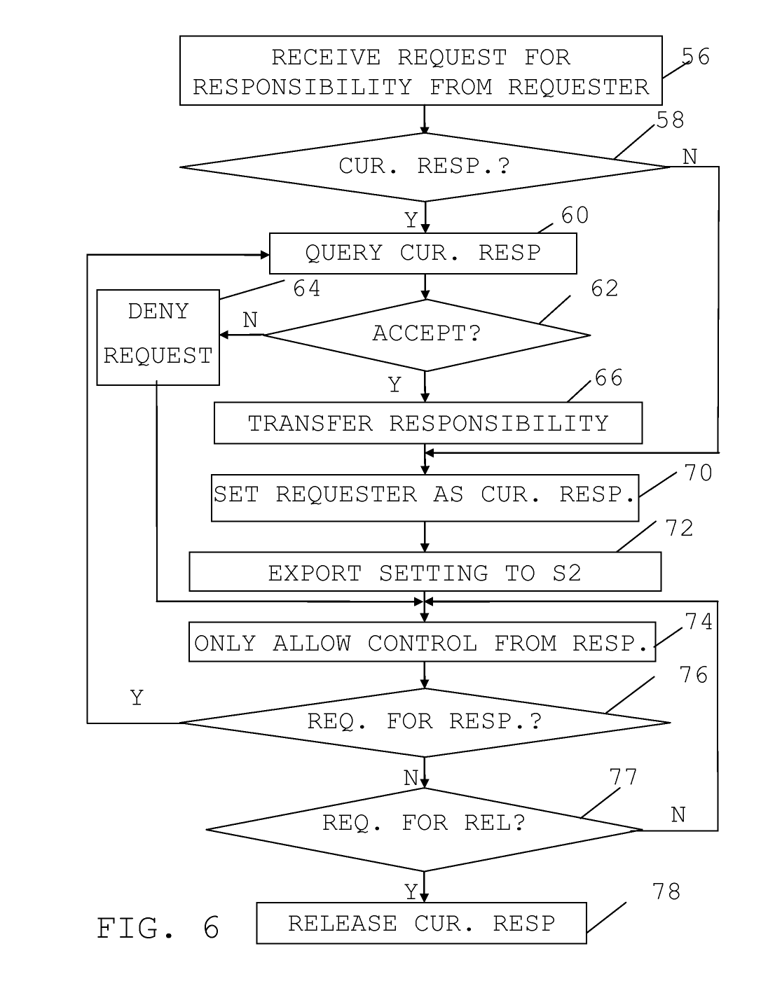

Another situation will now be described with reference being made to FIG. 7, which shows a number of further method steps that may be performed by the first object handling unit 40.

The first and second operators are in the example given above normally ranked operators assigned to handle the normal operation of the system. It is possible that such a normally ranked responsible operator is unable to perform a required control activity, for instance because of instant illness or some for some other reason. In this case it may be necessary for some higher ranked operator to step in and perform a required control activity. This would then be made without the consent of the currently responsible operator.

Thus, if there is a currently responsible operator in charge of an object and the first object handling unit 40 receives a demand for forced handover of responsibility concerning a group comprising this object, step 80, for instance from the third operator OP3 at the third operator terminal 32 via the second object handling unit 46, the RAC unit 44 and RAS unit 38, then the first object handling unit 40 first investigates the rank of the operator demanding forced handover of responsibility. In case the rank is higher than the rank of the currently responsible operator, then the higher rank is verified, step 82, and the responsibility transferred, step 84. Thereafter follows the setting of the new responsible operator, step 86, and optionally also exporting of setting to the second system, step 88, in the same way as was described earlier. The higher rank may here also have limitations. It may only be applicable for a certain section or even a certain object in the first system. In this way a transfer is performed irrespective of if the lower ranked operator agrees to the transfer of responsibility or not.

In the examples of the invention given so far there were only two systems, a first system on a first lower hierarchical level and a second system on a second higher hierarchical level. It should here be realized that there may be more systems.

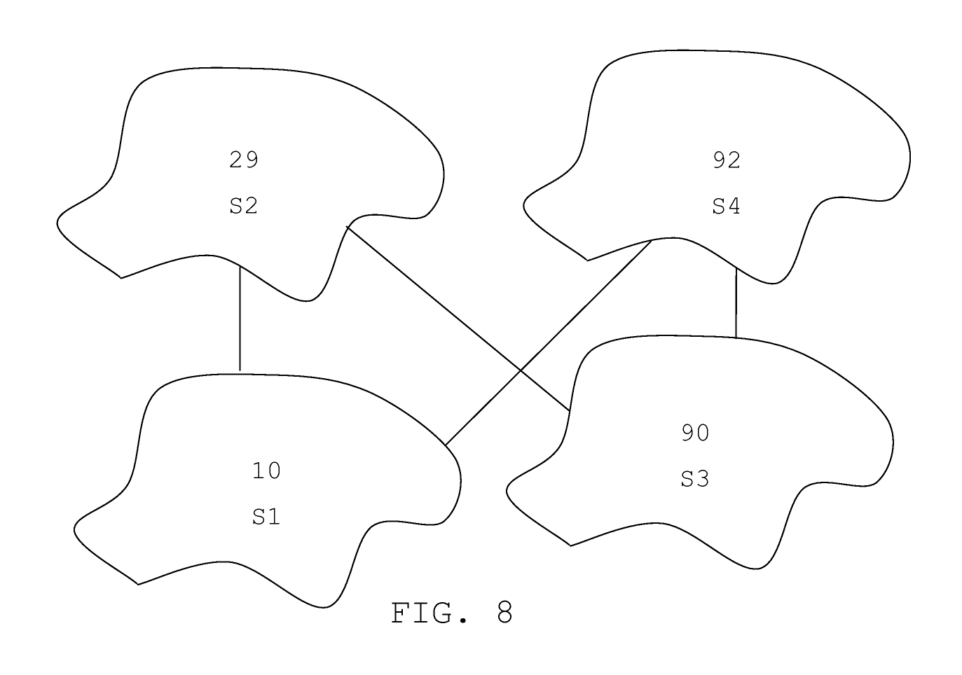

One example is given in FIG. 8, where there is a third system S3 90 and a fourth system S4 92. The third system 90 is on the same level as the first system 10, while the fourth system 92 is on the second higher level. Here the first system 10 is connected to the second and fourth systems 29 and 92 and the third system 90 is also connected to the second and fourth systems 29 and 92. However the first and third systems 10 and 90 are not connected to each other. They lack such a connection. Also the second and fourth systems 29 and 92 lack such a connection. Here it can be seen that responsibility of an object in the first system 10 can be transferred to the second system 29 and to the fourth system 92. However, it is not possible that responsibility of an object in the first system can be transferred to the third system 90 either from the first system 10, the second system 29 or the fourth system 92. The same situation also applies for objects in the third system 90. It is thus impossible to transfer responsibility of an object to another system on the same hierarchical level as the system in which the concerned object is provided. Also the first object handling unit may disallow any attempts to control or seize responsibility of an object in the first system by operators of the third system.

The object handling units in the control computers may be implemented through one or more processors together with computer program code for performing the functions of an object handling unit. The program code mentioned above may also be provided as a computer program product, for instance in the form of one or more data carriers carrying computer program code for performing the functionality of the object handling unit when being loaded into a control computer. One such carrier 94 with computer program code 96, in the form of a CD ROM disc is generally outlined in FIG. 9. It is however feasible with other data carriers, like memory sticks.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the present invention is only to be limited by the following claims.

1. A method for handling control of a computer object in a first system for controlling an industrial process, the object acting on a process interface device that influences the industrial process, the object being controllable from the first and from a second system by operators in these systems, the method being performed by an object control handling unit and comprising the steps of:
receiving, in the first system, a request from a requesting operator concerning responsibility of a group of objects comprising more than one object and said computer object,
setting, in the first system, an operator identified by said request to be responsible for the group, and
when responsible operator is set, only allowing control of the group from the responsible operator through acting on commands from the responsible operator and only the responsible operator,
wherein the request involves a transfer of responsibility from a currently responsible operator to a candidate responsible operator, where the candidate responsible operator is identified by the request and the requesting operator is either the currently responsible operator or the candidate responsible operator and there is a counterpart operator having the opposite role of the requesting operator, and further performing
querying the counterpart operator regarding accepting the transfer of responsibility, and
transferring responsibility of the group from the currently responsible operator to the candidate responsible operator identified in the request in dependence of the counterpart operator accepting the transfer, thereby making the candidate responsible operator into a currently responsible operator, wherein if a currently responsible operator is involved in a control task involving a series of control activities of a process interface device, this operator is only allowed to be relieved of the responsibility after the task is finished,
wherein the first system is a system on a first hierarchical level and the second system is a system on a second higher hierarchical level, where the requesting operator is an operator in the first or the second system and the counterpart operator is an operator in the other system, thereby making the transfer of responsibility involve a transfer from one of the systems to the other.

2. The method according to claim 1, further comprising exporting the setting of responsible operator to the second system.

3. The method according to claim 1, further comprising receiving a demand for forced handover from a further operator as the responsibility of the group is held by a currently responsible operator, said further operator being higher ranked than the currently responsible operator, verifying the higher rank of the further operator and transferring responsibility of the group to the further operator based on the verification of the rank.

4. The method according to claim 3, wherein the transfer is performed irrespective of if the lower ranked operator has accepted transfer of responsibility or not.

5. The method according to claim 1, further comprising setting the location of the operator when setting the responsible operator.

6. The method according to claim 5, wherein the location is limited to specifying the system of the operator if the operator is an operator in the second system.

7. The method according to claim 5, wherein the location is a section of the system where the operator is active if the operator is an operator in the first system.

8. The method according to claim 1, further comprising disallowing any attempts to control the objects in the group by operators of a third system on the same hierarchical level as the first system.

9. The method according to claim 1, further comprising simultaneously receiving two requests concerning responsibility of the group, one request identifying an operator in the first system and the other identifying an operator in the second system and prioritizing granting of responsibility to the operator in the first system.

10. A control computer in a first system and involved in controlling an industrial process via a computer object, the object acting on a process interface device that influences the industrial process, the object being controllable from the first and from a second system by operators in these systems, the control computer comprising:
an object handling unit configured to
receive a request from a requesting operator concerning responsibility of a group of objects comprising more than one object and said computer object,
set, in the first system, an operator identified by said request to be responsible for the group, and
when responsible operator is set, only allow control of the group from the responsible operator through acting on commands from the responsible operator and only the responsible operator,
wherein the request involves a transfer of responsibility from a currently responsible operator to a candidate responsible operator, where the candidate responsible operator is identified by the request and the requesting operator is either the currently responsible operator or the candidate responsible operator, where there is a counterpart operator having the opposite role of the requesting operator and the object handling unit is further configured to
query the counterpart operator regarding accepting the transfer of responsibility, and
transfer responsibility of the group from the currently responsible operator to the candidate responsible operator identified in the request in dependence of the counterpart operator accepting the transfer, thereby making the candidate responsible operator into a currently responsible operator, and if a currently responsible operator is involved in a control task involving a series of control activities of a process interface device, the object handling unit is configured to only allow this operator to be relieved of the responsibility after the task is finished,
wherein the first system is a system on a first hierarchical level and the second system is a system on a second higher hierarchical level, where the requesting operator is an operator in the first or the second system and the counterpart operator is an operator in the other system, thereby making the transfer of responsibility involve a transfer from one of the systems to the other.

11. The control computer according to claim 10, wherein the object handling unit is further configured to export the setting of responsible operator to the second system.

12. The control computer according to claim 10, wherein the object handling unit is further configured to receive a demand for forced handover from a further operator as the responsibility of the group is held by a currently responsible operator, said further operator being higher ranked than the currently responsible operator, verify the higher rank of the further operator and transfer responsibility of the group to the further operator based on the verification of the rank.

13. The control computer according to claim 12, wherein the object handling unit is further configured to perform the transfer irrespective of if the lower ranked operator has accepted transfer of responsibility or not.

14. The control computer according to claim 10, wherein the object handling unit is configured to simultaneously receive two requests concerning responsibility of the group, one request identifying an operator in the first system and the other identifying an operator in the second system and to prioritize granting of responsibility to the operator in the first system.

15. A computer program product for handling control of a computer object in a first system for controlling an industrial process, the object acting on a process interface device that influences the industrial process, the object being controllable from the first and from a second system by operators in these systems,
the computer program product comprising a data carrier with computer program code implementing an object handling unit of a control computer in the first system, the computer program code being configured to, when the code is loaded in the control computer:
receive a request from a requesting operator concerning responsibility of a group of objects comprising more than one object and said computer object,
set, in the first system, an operator identified by said request to be responsible for the group, and
when responsible operator is set, only allow control of the group from the responsible operator through acting on commands from the responsible operator and only the responsible operator,
wherein the request involves a transfer of responsibility from a currently responsible operator to a candidate responsible operator, where the candidate responsible operator is identified by the request and the requesting operator is either the currently responsible operator or the candidate responsible operator, where there is a counterpart operator having the opposite role of the requesting operator and the code is further configured to
query the counterpart operator regarding accepting the transfer of responsibility, and
transfer responsibility of the group from the currently responsible operator to the candidate responsible operator identified in the request in dependence of the counterpart operator accepting the transfer, thereby making the candidate responsible operator into a currently responsible operator, and if a currently responsible operator is involved in a control task involving a series of control activities of a process interface device, to only allow this operator to be relieved of the responsibility after the task is finished,
wherein the first system is a system on a first hierarchical level and the second system is a system on a second higher hierarchical level, where the requesting operator is an operator in the first or the second system and the counterpart operator is an operator in the other system, thereby making the transfer of responsibility involve a transfer from one of the systems to the other.
